(19) United States
(12) Patent Application Publication
(10) Pub. No.: US 2005/0246773 A1
(43) Pub. Date: Nov. 3, 2005

(54) System and methods for processing partial trust applications

(75) Inventors: Sean C. Draine, Seattle, WA (US); James R. Schmelzer JR., Seattle, WA (US); Ernest K. Tong, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/835,042

(22) Filed: Apr. 29, 2004

(51) Int. Cl. H04L 9/00; H04L 9/32; G06F 11/30; G06F 12/14

(52) U.S. Cl. 726/22

(57) ABSTRACT

The present invention provides an extensible mechanism for highlighting and displaying security components or elements that are to be employed for a given application context. In one aspect, a system is provided for computerized code development environments. The system includes a data source that stores one or more application components. A security component automatically analyzes the application components with respect to security information associated with the application components. A feedback component provides information related to a given development security context in view of the security information.

### TECHNICAL FIELD

The present invention relates generally to systems and methods that facilitate code development activities, and more particularly, the present invention relates to a security analysis process wherein security elements of an application are analyzed in view of a current code context in a development environment and developers are provided with feedback indicating security element availability given the current context.

### BACKGROUND OF THE INVENTION

Software development systems provide many tools enabling developers to create applications often consisting of disparate software components. One such situation involves creating applications whereby one or more security considerations may be associated with respective components of the application. For example, many components of an application often contain security permissions that are associated as part of metadata for a file. These security permissions describe what type of access may be granted to a respective file—for example, whether or not read only access is to be given to a file or whether the file should be given read/write access. As can be appreciated, a plurality of such security designations can be declared (e.g., global security rights versus individual sercurity rights).

Presently with current software development tools, it is unclear at the time of development what security elements may be available or unavailable given a current development context. For example, current systems require developers to search through an Application Programming Interface (API) documentation set or to actually deploy and test an application to determine whether a respective API call was permitted within a target development security context. This type of searching is wasteful since it often requires developers to lose time searching for desired security elements or worse—repeat code development operations after determining that desired security functionality is missing. In many cases, the security metadata for a component may not exist in human readable form, in which case the developer can only discover the security requirements through the tedious process of deploying and testing the code in the target security context.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to systems and methods that facilitate determination and presentation of security components in a code development environment. In one aspect, a security analyzer and interface is provided that displays lists of Application Programming Interfaces (APIs) or other security components that are available to a developer in a particular coding security context such as in a source code editor as the developer edits application code. This can include displaying metadata regarding available APIs, such as brief descriptions of the APIs purpose and parameters accepted by the API. The present invention supplements these displays with code access security metadata for namespaces, classes, and members in managed data assemblies (e.g., Net). Thus, developers can specify a code access security context for their respective application (e.g., the set of permissions the application has), wherein visual or other type feedback is then automatically provided that marks or indicates which APIs are available or unavailable in that security context. In this manner, developers are made aware on the front-end of development which security elements may be missing for an application, and thus can save time associated with discovering at a later time (e.g., during debug) that security components are missing or still required.

In general, developers and other IT professionals can select between a number of competing platforms for building rich, secure client applications for desktop applications. Thus, the quality of tools for a platform is an important factor that should be addressed when supplying tools for the platform. The present invention provides a model for Partial Trust Applications that enables developers to quickly and easily understand/determine which APIs (or other security components) are available for their application which runs under a particular security context, and which APIs may require additional permissions. The subject invention makes it easy to develop applications that function correctly in restricted security contexts by enabling developers to identify potential security issues (e.g., via a user interface highlighting such issues) as they are writing code rather than discovering the problems later on as they debug the application.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating a code development system in accordance with an aspect of the present invention.

FIG. 2 is a diagram illustrating example security output in accordance with an aspect of the present invention.

FIG. 3 is a diagram illustrating an example user interfaces for displaying security output in accordance with an aspect of the present invention.

FIG. 4 illustrates example design time metadata in accordance with an aspect of the present invention.

FIG. 5 illustrates an example storage implementation for metadata in accordance with an aspect of the present invention.

FIG. 6 illustrates exemplary XML document considerations in accordance with an aspect of the present invention.

FIG. 7 is a flow diagram of a security development process in accordance with an aspect of the present invention.

FIG. 8 is a schematic block diagram illustrating a suitable operating environment in accordance with an aspect of the present invention.

FIG. 9 is a schematic block diagram of a sample-computing environment with which the present invention can interact.

### DETAILED DESCRIPTION OF THE INVENTION

The present invention provides an extensible mechanism for highlighting and displaying security components or elements that are to be employed for a given application context. In one aspect, a system is provided for computerized code development environments. The system includes a data source that stores one or more application components (e.g., application files residing in a database that are employed to construct an application). A security component automatically analyzes the application components with respect to security information associated with the application components (e.g., XML security metadata associated with the application components). A feedback component then provides information related to a given development security context (e.g., declared by a developer via a development tool) in view of the security information. For example, a code developer may declare an application having various disparate software components or files that cooperate to form a desired application under development. The developer, in the context of declaring the application components can specify desired security configurations for the application or target. When the application components are retrieved from the data source, the feedback component provides a listing or other type output indicating which security information may be available or unavailable given the development security context. In this manner, missing security elements can be accounted for before applications are actually built and run which provides appreciable time savings over previous systems.

As used in this application, the terms “component,” “model,” “system,” “analyzer,” “object,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

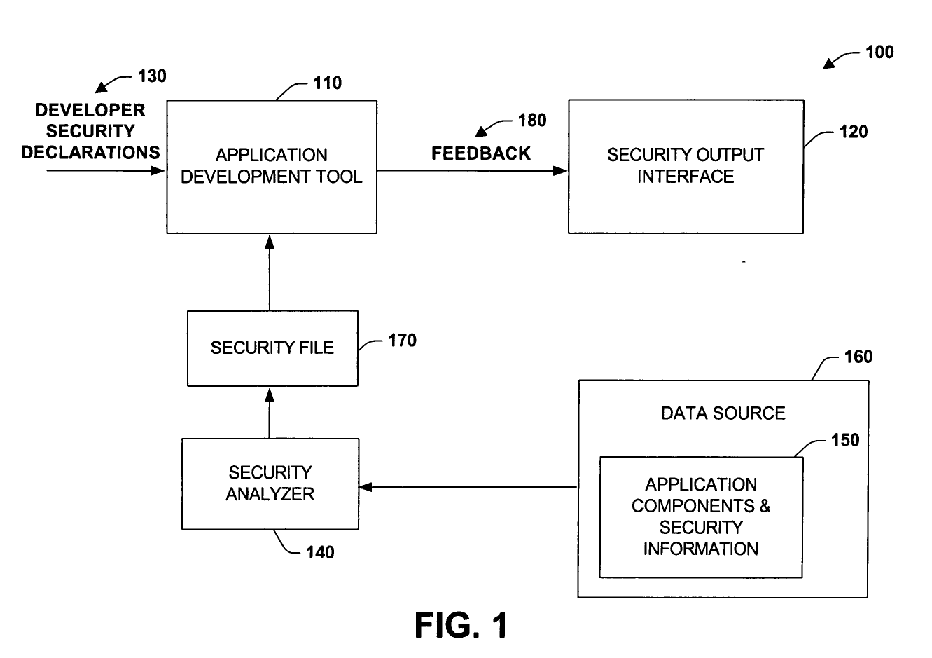

Referring initially to FIG. 1, a code development system 100 is illustrated in accordance with an aspect of the present invention. The system 100 includes an application development tool 110 (also referred to as tool) (e.g., Visual Studio or other development system) that interacts and communicates with a security output interface 120. In general, in the context of a code development environment, a developer indicates desired security declarations at 130 that serve to define security requirements for an application or target under development via the tool 110. A security analyzer 140 (e.g., background component that processes security metadata) receives application components 150 from a data source 160 (for an application under development), wherein the components can have security information associated therewith (e.g., XML security metadata). The data source 160 can include local or remote databases such as can be communicated (cable or wireless) across a local network or remote networks such as the Internet, for example.

In general, the security analyzer 140 determines which security elements may be available or unavailable given a security context defined by the developer at 130. This can include automatic creation of a security file 170 that indicates current security considerations for the application components 150. For example, the security analyzer 140 can determine available security permissions for the components 150. Based upon the security declarations at 130, and the security file 170, the tool 110 generates feedback 180 to the security output interface 120 that provides indications of the types of security that may be available or unavailable for the application under development by the tool 110. For example, the security output interface 120 can display lists of application components 150 such as Application Programming Interfaces (APIs) or other security components that are available to a developer in a particular coding security context such as in a source code editor (not shown) at the tool 110 as the developer edits application code. This can include displaying metadata regarding available APIs, such as brief descriptions of the APIs purpose and parameters accepted by the API. The system 100 supplements these displays with code access security metadata for namespaces, classes, and members in managed data assemblies (e.g., Net). It is noted that managed assemblies and classes are generally associated with a managed code environment having a garbage collector or other component for automatically managing object lifetimes.

Developers can specify a code access security context for their respective application (e.g., the set of permissions the application has) at 130, wherein visual or other type feedback 180 is then automatically provided that marks or indicates which APIs or components are unavailable in that security context. In this manner, developers are made aware on the front-end of development which security elements may be missing for an application, and thus can save time associated with discovering at a later time (e.g., during debug) that security components are missing or still required.

It is noted that the security output interface 120 can be provided as a Graphical User Interface (GUI). For example, the interface 120 can include one or more display objects (e.g., display icon) that can include such aspects as configurable icons, buttons, sliders, input boxes, selection options, menus, tabs and so forth having multiple configurable dimensions, shapes, colors, text, data and sounds to facilitate operations with the systems described herein. In addition, user inputs (e.g., supplied with the tool 110) can include a plurality of other inputs or controls for adjusting and configuring one or more aspects of the present invention. This can include receiving user commands from a mouse, keyboard, speech input, web site, browser, remote web service and/or other device such as a microphone, camera or video input to affect or modify operations of the various components described herein.

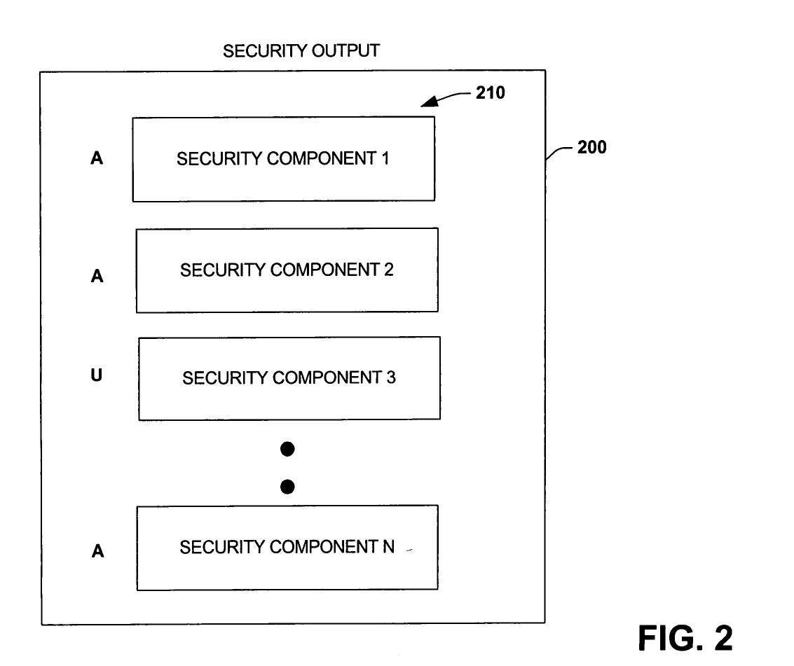

Referring now to FIG. 2, example security output 200 is illustrated in accordance with an aspect of the present invention. The security output 200 includes a display or other type output (e.g., audio declaration) of one or more security components 210 that may be available or unavailable for a given security context. For example, a first and second security component have an “A” illustrated next to the component indicating that these components are available for a given or selected security context. A third security component is designated with a “U” indicating that this component or element is missing from the application. As can be appreciated, a plurality of components can be shown via the security output 200, wherein the respective components can be tagged or highlighted as available or unavailable depending on the current development or context.

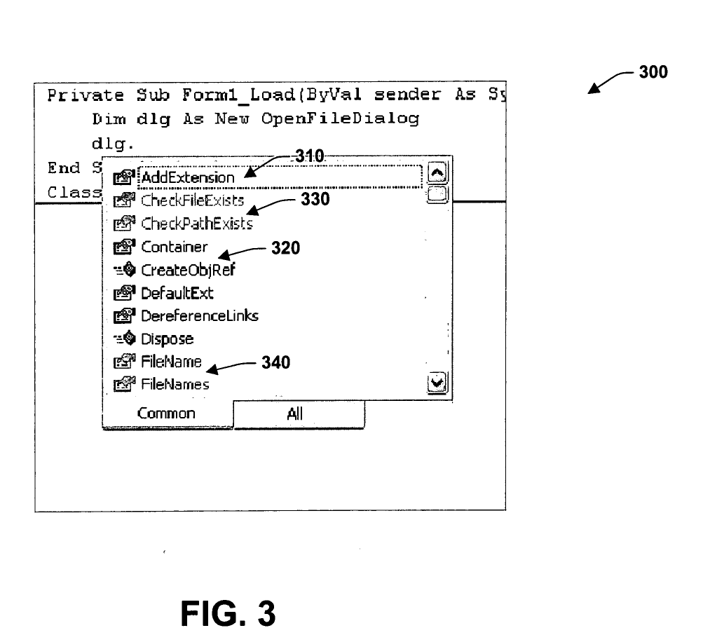

Upon observing the security output 200, a developer can be instructed that other security items should be added before constructing or building a respective application. In one example, if the developer highlights or selects components designated as currently unavailable, a tool tip or other interface can pop-up and display possible remedies such as providing an alternative path for selecting the currently unavailable security component. As can be appreciated, there can be a plurality of different techniques for designating available and/or unavailable security components or files. As will be described in more detail with respect to FIG. 3, available security items can be highlighted or in bold, whereas unavailable items can be de-emphasized or other indication that the item is currently missing from a respective application under development.

Turning to FIG. 3, an example user interface 300 for displaying security output is illustrated in accordance with an aspect of the present invention. In this aspect, an example development situation is depicted, wherein the interface 300 displays various components of an application. In this example, highlighted components at 310 and 320 indicate elements of an application that are available for the given context. For example, element 310 indicates an AddExtension, whereas the elements 320 include a container, Create Object Reference, default extensions, dereference links and a dispose element. At 330 and 340, unavailable elements are de-emphasized or in this example, non-highlighted versus elements 310 and 320. For example, the elements at 330 include a check file exists and a check path exists declaration, whereas the elements at 340 include a file name and file names designation. Thus, upon viewing the interface 300, a developer can easily determine that the elements at 330 and 340 need to be accounted for and added to the existing application under development in order to comply with desired security requirements for the application.

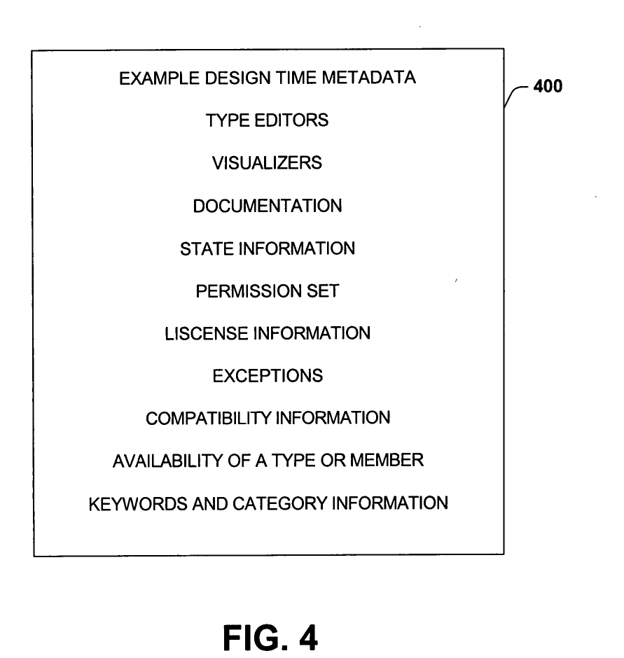

FIG. 4 illustrates example design metadata 400 in accordance with an aspect of the present invention. In one aspect, the design metadata 400 describes the security elements or components described above such as a permission set required for a particular type or member. Design time metadata 400 can include information about a code library that is typically accessed and used at application development time but not at application run time. Design time metadata is generally provided to inform or aid the developer. Examples of design time metadata 400 include:
1. Type editors for editing types and members
2. Debugger visualizers for viewing type and member state at debug time.
3. Documentation describing purpose and function of types.
4. Information about how the state of a component should be serialized into code.
5. The permission set required by a type or member.
6. License for using a type at design time.
7. List of exceptions that a method may throw.
8. Deployment requirements for an assembly.
9. Compatibility information with previous versions of an assembly.
10. Availability of a type or member on a particular compact framework platform.
11. Keywords and category information for component library searches.

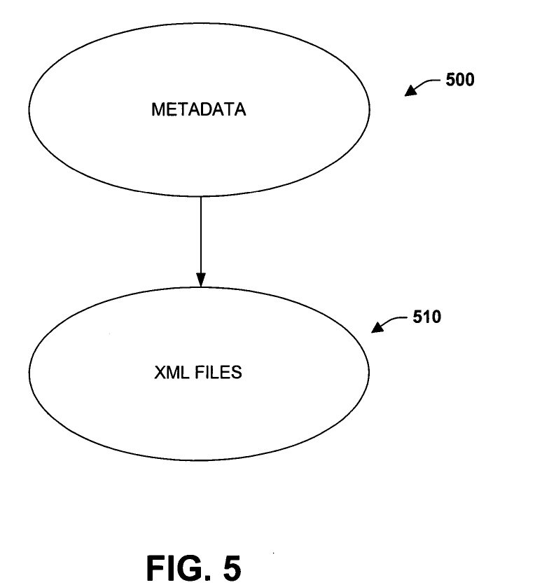

FIG. 5 illustrates an example storage implementation for metadata 500 in accordance with an aspect of the present invention. In this aspect, a second model for storing design time metadata 500 is related to compiler-generated XML comments. For example, metadata used by the development tool described above can be stored as XML document files at 510. It is to be appreciated that other types of languages than XML can be employed. The XML files 510 can include summary descriptions of APIs, classification of components as common vs. advanced, and the permission set required by each API for as previously noted. Each assembly can have an associated XML document comments file 510 with a matching name (e.g., system.data.dll maps to system.data.dll.xml).

Some benefits of XML document comments having associated security metadata can include:

Easy Reuse Across Tools and Languages.

The metadata is stored as XML, making it open to any tool that desires to read the metadata.

3rd Parties Library Vendors can Participate.

Third parties can easily generate the XML document comment files for their assemblies, thereby providing rich tool support around their class libraries.

Potential for Community Participation.

Developers can write custom type editors and debugger visualizers that can be plugged into development tools simply by modifying the XML. This can include defining additional metadata sections, such as best practices, additional documentation, and so forth along with tools and add-ins that leverage this metadata.

Little or no Impact on Current System Performance and Working Set.

Since XML document comments are typically stored in separate files from actual assemblies, it is possible for applications to load assemblies without automatically incurring the cost of loading the associated design time metadata.

Metadata can be Added or Modified Without Rebuilding the Assembly.

This makes it possible to retrofit metadata onto previously shipped assemblies. It thus may be easier to fix bugs in metadata. It can also empower users to add metadata to assemblies they cannot build themselves, or even correct errors in existing metadata.

Metadata can be Owned by Tools as Appropriate.

The process of generating XML document comments is quite flexible, allowing metadata to be defined and merged from multiple sources. Flexible ownership allows tools to mitigate dependencies on component owners where necessary or appropriate.

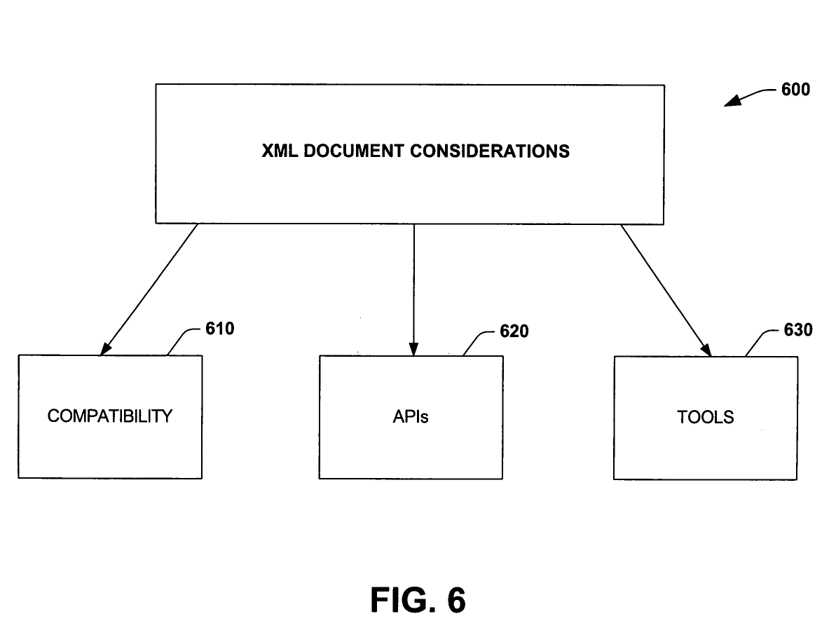

FIG. 6 illustrates exemplary XML document considerations 600 in accordance with an aspect of the present invention. In general, the considerations 600 include example design considerations for implementing the XML documents or comments described above. For example, at 610, these can include backwards compatibility issues with existing systems. Existing systems using custom attributes may continue to exist for the purpose of backwards compatibility. APIs for accessing custom attributes can be provided to support locating metadata stored in XML documents as well as with respect to custom attributes. At 620, one or more APIs for retrieving metadata can be provided. This can include providing an API for retrieving design time metadata to make it easier to avoid multiple teams having to supply similar functionality. Also, since XML documents can grow large with time, the APIs should support efficient stream-based loading of a desired subset of metadata without requiring the entire document to be loaded into memory, if desired. At 630, tools for post-build processing of XML documents can be provided. Internal and external users may have requirements for generating XML that go beyond what can easily be generated by the compiler. For example, development tools may consume security metadata that is produced by a Minimum Grant Determiner or other component, for example. This and other metadata can be merged into the XML documents as part of a separate build process. As another example, users may want to supplement XML documents for 3rd party assemblies with internal metadata, such as best practices, recommendations for API use, and so forth.

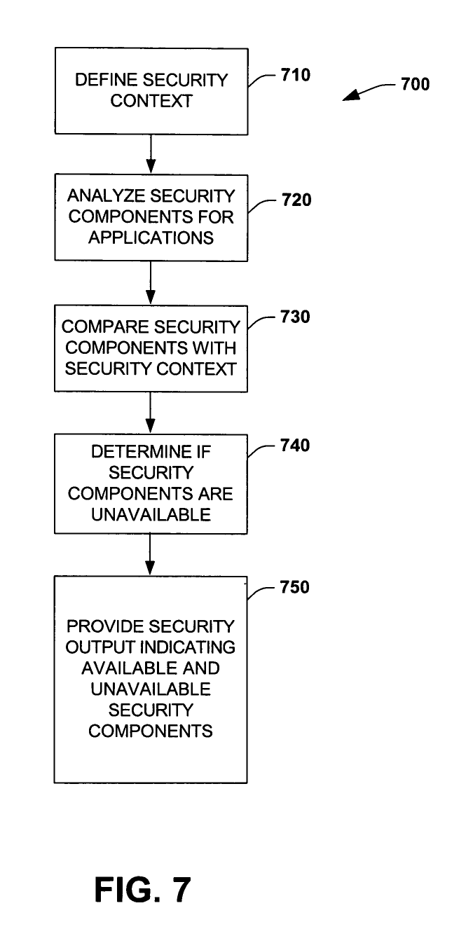

FIG. 7 is a process 700 illustrating a security development methodology in accordance with an aspect of the present invention. While, for purposes of simplicity of explanation, the methodology is shown and described as a series or number of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Proceeding to 710, a security context is defined. As noted above, this is usually determined by a developer during design of an application employing commercially available software development tools. At 720, respective security components are analyzed for an application under development. For example, this can include analyzing security metadata such as a permission set for the respective components of the application. At 730, the security components are compared to the given security context to determine whether the respective security component is available for the given security context at 740. At 750, security output is generated indicating which security components are available for the given context (if any) and which security components are unavailable for the given context (if any). As noted above, substantially any type of audio or visual feedback can be employed to indicate available and/or unavailable security components (e.g., highlight available and de-emphasize unavailable).

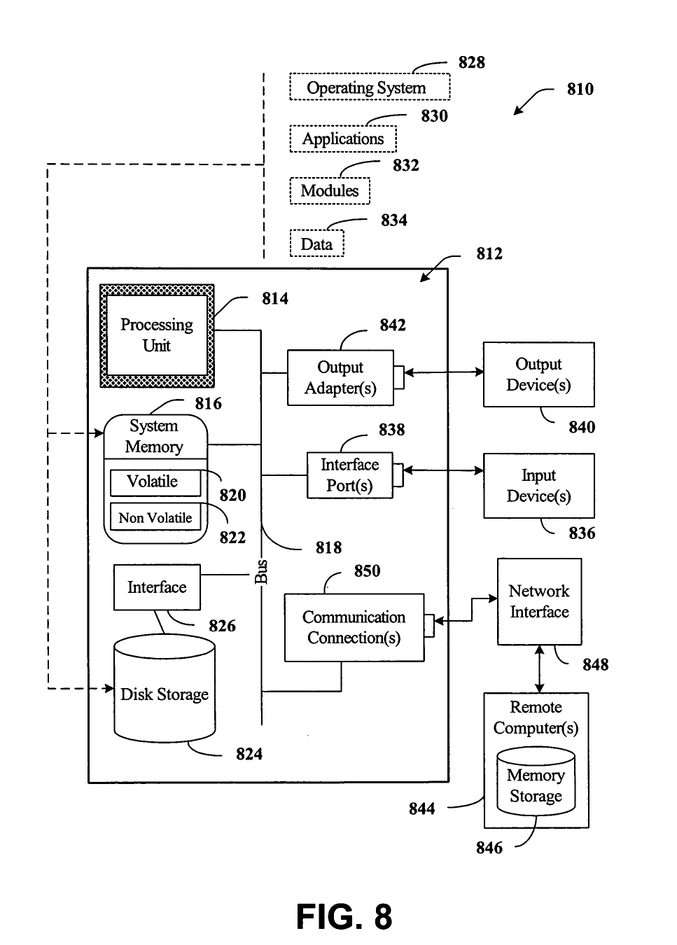

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

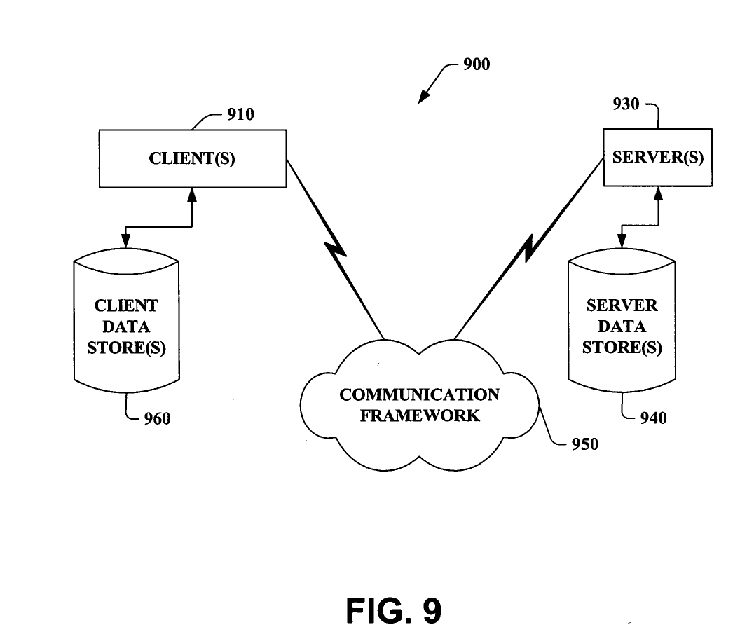

FIG. 9 is a schematic block diagram of a sample-computing environment 900 with which the present invention can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the present invention, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes examples of the present invention. It is, of course, not possible to describe every conceivable combination of components or methodologies for purposes of describing the. present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system for computerized code development environments, comprising:
a data source that stores one or more application components;
a security component that analyzes the application components with respect to security information associated with the application components; and
a feedback component that provides information related to a given development security context in view of the security information.

2. The system of claim 1, the feedback component provides output to a graphical user interface associated with a code development component.

3. The system of claim 2, the code development component receives input from a developer that indicates desired security declarations for an application or target under development.

4. The system of claim 1, the security analyzer operates as a background component that processes security metadata associated with the application components.

5. The system of claim 1, the data source is associated with local or remote database having information communicated across a local network or remote network.

6. The system of claim 5, the information is communicated via wireless or wired network components.

7. The system of claim 1, the security analyzer determines which security elements are available or unavailable given a security context defined by a developer.

8. The system of claim 7, the security analyzer automatically creates a security file that indicates current security considerations for the application components.

9. The system of claim 8, the security file is employed to determine differences between developer security declarations and metadata associated with the application components.

10. The system of claim 9, the metadata drives a display of available Application Programming Interfaces (APIs) including brief descriptions of the APIs purpose and parameters accepted by the API.

11. The system of claim 9, the metadata includes code access security metadata for namespaces, classes, and members in managed data assemblies.

12. The system of claim 9, the metadata is associated with one or more security permissions.

13. The system of claim 12, the metadata is associated with at least one of a type editors for editing types and members, a debugger visualizer for viewing type and member states at debug time, a documentation item, information about how a state of a component should be serialized into code, a license for using a type at design time, a list of exceptions that a method may throw, a deployment requirement for an assembly, compatibility information with previous versions of an assembly, availability of a type or member, a keyword, and category information for component library searches.

14. The system of claim 1, the feedback component generates a list of files associated with a given security context.

15. The system of claim 14, the list of files includes APIs, functions, or components that are marked as available if files in the list are determined to be available in a given security context and marked as unavailable if determined to be unavailable in a given security context.

16. The system of claim 15, the available files are highlighted and the unavailable files are de-emphasized.

17. The system of claim 16, further comprising a tool tip for declaring, defining, or locating the unavailable files.

18. The system of claim 1, the security information is stored in the data source as an XML document relating to compiler-generated comments.

19. The system of claim 1, the security information is associated with custom attributes.

20. A computer readable medium having computer readable instructions stored thereon for implementing the components of claim 1.

21. A system for computerized development environments, comprising:
means for declaring a security context for an application under development;
means for analyzing security components associated with one or more components of the application; and
means for displaying differences between the security context and the components of the application.

22. The system of claim 21, the security components are associated with XML metadata.

23. A method for displaying security data for an application, comprising:
defining a security context for an application;
determining security permissions for application components of the application;
comparing the security context with the security permissions; and
marking files as available or unavailable depending on the security permissions.

24. The method of claim 23, further comprising providing audio or visual feedback relating to the available or unavailable files.

25. The method of claim 23, further comprising automatically providing a tips display relating to the unavailable files.

26. The method of claim 23, further comprising automatically generating the security permissions as XML comments.

27. A graphical user interface for a development system, comprising:
a security component that analyzes security permissions for an application;
a development tool that determines a security context for the application; and
a user interface component that displays differences between the security context and the security permissions.
